(19) United States
(12) Patent Application Publication
(10) Pub. No.: US 2004/0100871 A1
(43) Pub. Date: May 27, 2004

(54) Multifunctional clock

(76) Inventor: Nobuyuki Yamazaki, Tokyo (JP)

Correspondence Address: Rocco S. Barrese, Esq., DILWORTH & BARRESE, LLP, 333 Earle Ovington Blvd., Uniondale, NY, 11553, US

(21) Appl. No.: 10/304,622

(22) Filed: Nov. 26, 2002

(51) Int. Cl. G04C 19/00

(52) U.S. Cl. 368/82

(57) ABSTRACT

The present invention is directed to a multifunctional clock, which displays a variety of functions such as time, date, temperature, etc. upon a single liquid crystal display.

### BACKGROUND OF THE INVENTION

The present invention is directed to a multifunctional clock which can display different functions such as time, date, temperature, and activate an alarm. More particularly, the present invention is directed to such a multifunctional clock which successfully integrates all such functions within a single liquid crystal display.

There is a tremendous need to provide a multifunctional clock which can easily display such features, and which can also be easily calibrated and reset as needed without inadvertently resetting all the different functions at once. Furthermore, since such timepieces involve displaying numerals for all the different functions, it is not often easy to tell which function is being displayed by simply looking at the numerals.

Accordingly, it is an object of the present invention to improve display of time, calendar, temperature and provide an alarm function that can be easily activated and deactivated.

It is also an object of the present invention to provide a multifunctional timepiece that can be easily set and reset as desired for a particular function, without disturbing any of the other functions provided by the timepiece.

It is a further object of the present invention to provide a multifunctional clock in which the particular function displayed can be quickly ascertained with no difficulty.

### SUMMARY OF THE INVENTION

These and other objects are attained by the present invention which is directed to a multifunctional clock having the ability to display time, calendar, temperature and sound an alarm, in which a separate icon or logo is displayed both upon the screen presenting the reading and separately and apart from such screen. Such a multifunctional clock or timepiece greatly expedites ease of reading the displayed function and also setting or resetting the displayed function.

### BRIEF DESCRIPTION OF THE DRAWINGS

The present invention will be described in greater detail with reference to the accompanying drawings in which:

FIG. 1 illustrates a front elevational view of the multifunctional clock in accordance with the present invention;

FIG. 2 illustrates a top plan view of the multifunctional clock shown in FIG. 1;

FIG. 3 illustrates a left side elevational view of the multifunctional clock shown in FIG. 1;

FIG. 4 illustrates a right side elevational view of the multifunctional clock shown in FIG. 1;

FIG. 5 illustrates a rear elevational view of the multifunctional clock shown in FIG. 1;

FIG. 6 is a right side elevational view, similar to FIG. 4 and illustrating the multifunctional clock in supported upright position;

FIG. 7 is a right perspective view of the multifunctional clock shown in FIG. 7;

FIG. 8 is a schematic front view of the multifunctional clock prior to calibrating all functions;

FIG. 9 is a schematic front view of the multifunctional clock illustrating display of time;

FIG. 10 is a schematic front view of the multifunctional clock illustrating display of calendar;

FIG. 11 is a schematic front view of the multifunctional clock illustrating display of temperature;

FIG. 12 schematically illustrates the circuitry used to operate the multifunctional clock of the present invention; and

FIG. 13 schematically illustrates interrelationship between motion sensing and the multifunctional display upon the inventive clock.

### DESCRIPTION OF THE PREFERRED EMBODIMENTS

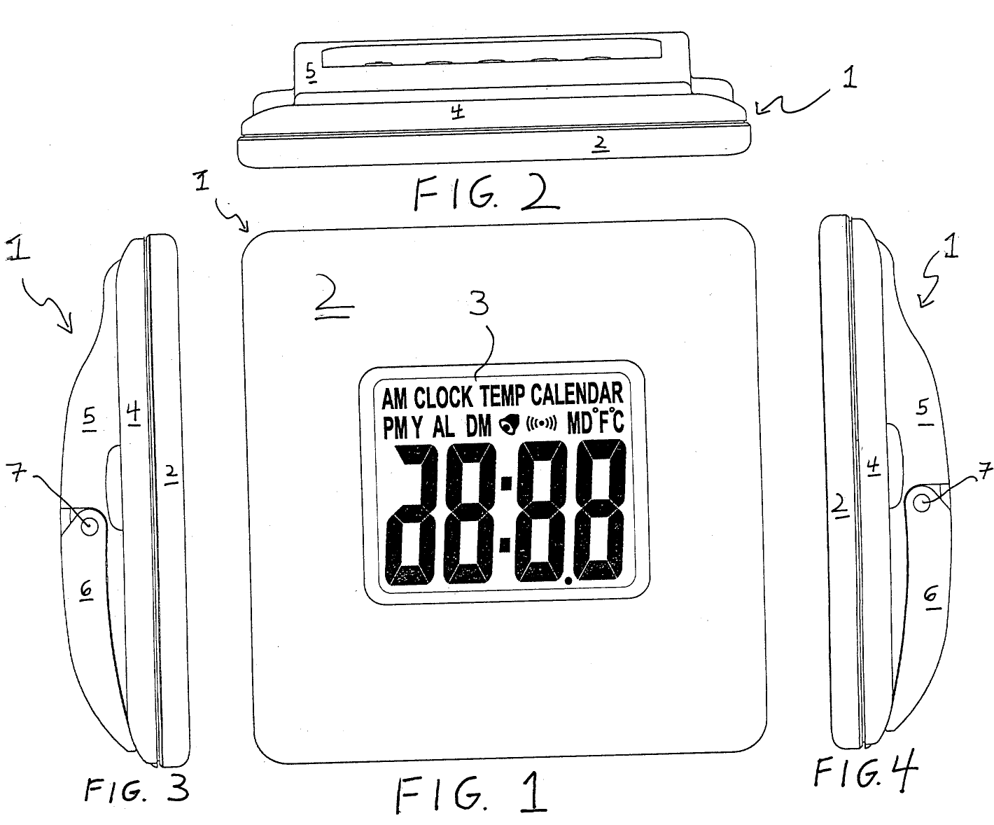

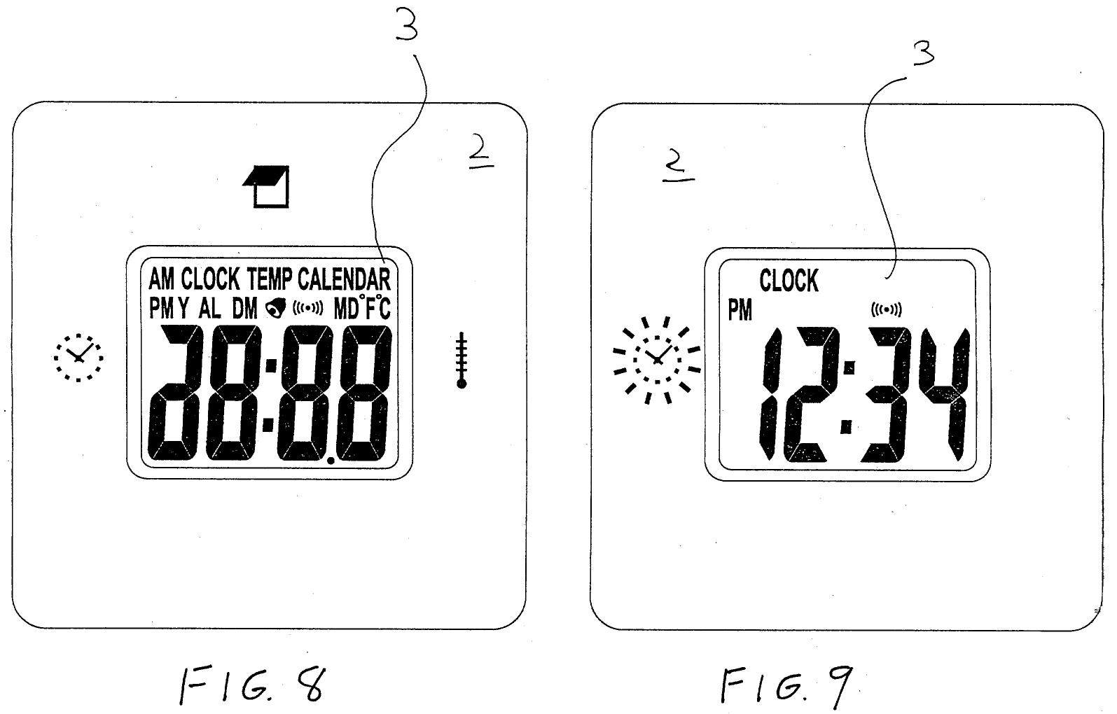

The multifunctional clock 1 of the present invention is illustrated in FIGS. 1-7 as possessing a front face 2 on which a screen 3, e.g., a liquid crystal display, is positioned. A container 4 for operational circuitry (FIG. 12) and battery is coupled to the front face 2, with a control panel 5 affixed to the rear of this container 4. A pivotal support or brace 6 is pivotally mounted to the control panel 5 about pivot hinge 7 so that the clock 1 can be uprightly positioned as shown in FIGS. 6 and 7 to more easily view the display screen 3.

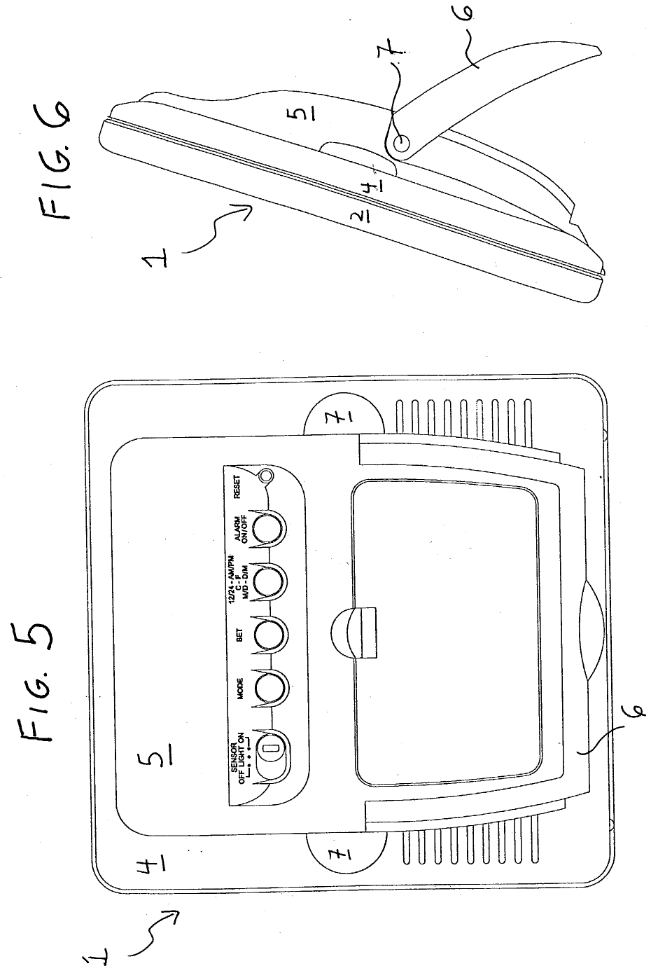

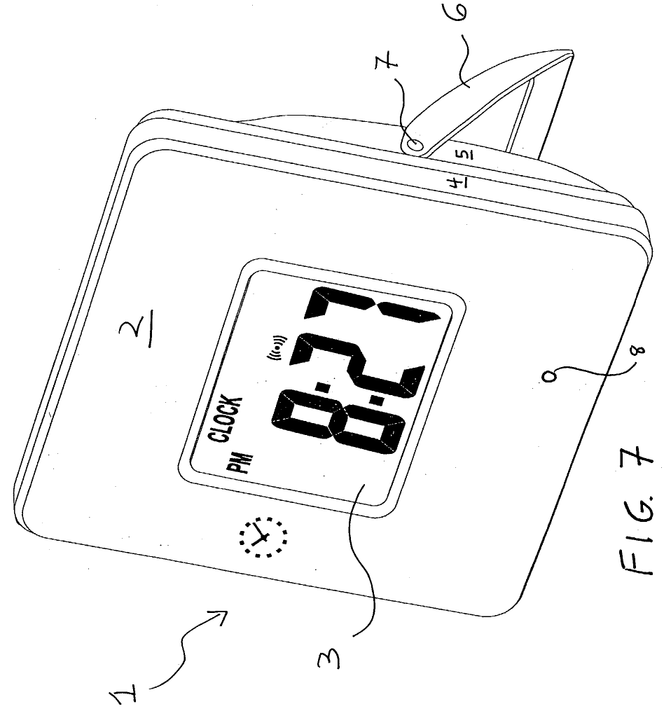

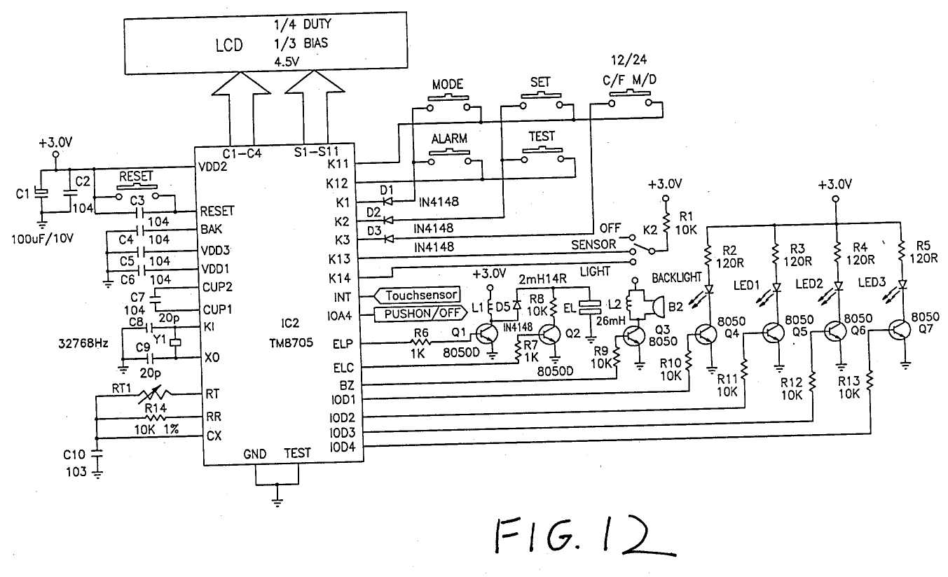

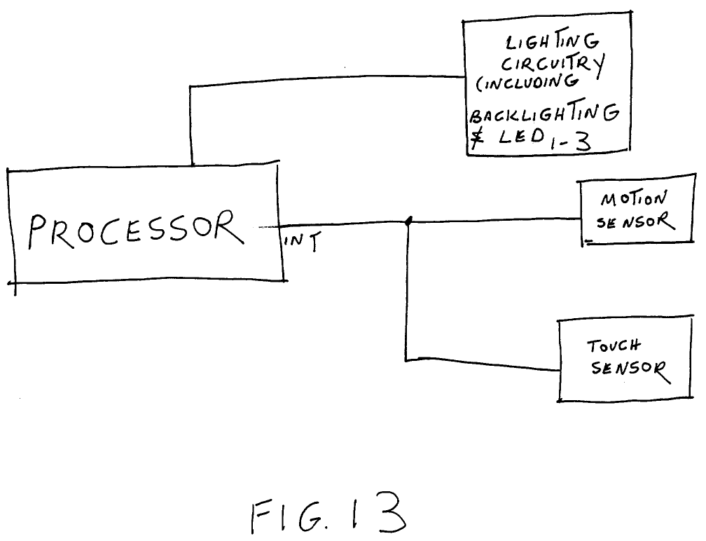

Situated about the screen 3 on the clock face 2 are various icons illustrating the particular function being displayed upon the screen 3. These icons denote the respective display functions of time (FIGS. 7 and 9), calendar (FIG. 10) and temperature (FIG. 11). These icons are constituted by light emitting diodes (LEDs) in the preferred embodiment. The various switches or buttons for activating and setting/resetting the functions of the clock in conjunction with the circuit diagram shown in FIG. 12, can be seen in the rear elevational view of FIG. 5. Reference numeral 8 in FIG. 7 denotes a motion sensor, to be described further, infra.

Referring to the circuit diagram shown in FIG. 12, the interrelationship of the various icon LEDs with the liquid crystal display (LCD) on the screen 3, is shown. Additionally, the temperature sensor in the clock is constituted by the RT-CX circuitry shown in the circuit diagram of FIG. 12. The TOUCH SENSOR shown in the circuit diagram provides signals to the clock to change display among time, calendar and temperature. If the TOUCH SENSOR suddenly malfunctions, the TEST button or key can produce an equivalent signal to substitute for the TOUCH SENSOR on the demo board only. ELP and ELC denote two output pins to turn on the backlighting, EL. The PUSH ON/OFF button is an extra pin which is used to control on/off of the LOGO or icons displayed upon the screen 3 and adjacent the screen 3. The integrated circuit chip, TM 8705 used to operate the circuit is manufactured by Tenx Technology, Inc., Taipei, Taiwan. Furthermore, the TOUCH SENSOR can detect the motion of an individual at the rate of one second, to activate the backlighting.

The multifunctional clock provides full calendar display over the years 2000-2050 with the display format selectable between month/day or day/month (the European style). Real time clock format can be selected between standard 12 hour display (a.m. or p.m.) or 24 hour (marine time) display by the hour and minute. A daily alarm function and hourly chime function are also provided. Automatically activated backlighting function is provided with an optional feature of an LED backlighting icon. An optional “LOGO ON” or icon-on feature can be provided. The thermometer function is selectable to display Celsius or Fahrenheit degrees. As shown in FIG. 5, a total of five keys are required to set and calibrate the multifunctional clock 1, with the icons reflected by three different LEDs.

More particularly and referring to FIG. 5, the three-position sliding switch controls the ON/LIGHT/OFF function in the following manner. The ON position of this switch activates a sensor for mode changing, the OFF position deactivates the sensor while a user can change function by pressing the MODE button, and the LIGHT position activates the sensor for backlighting the screen 3, with an LED indicator and logo (icon) for the backlighting being optional. If the switch remains in the LIGHT position then, as with the OFF position, a function can only be changed by pressing the MODE button. More specifically, when the switch is in the OFF position, then no backlighting or logo appears; when the switch is in the LIGHT position, the backlighting and logo appear for 3 seconds when touch or motion occurs; and when the switch is in the ON position, then the backlighting and logo turn on for three seconds when the MODE button is pressed.

When changing different functions by pressing the MODE button when the switch is set to the OFF or LIGHT position, the CLOCK symbol is displayed first, followed by the CALENDAR symbol, then by the TEMP symbol, then by the CLOCK symbol again, etc. The SET button in FIG. 5 can be used to set different parameters when the switch is in the OFF or LIGHT position and to stop the alarm sound when the switch is located in any of its three positions, namely ON, OFF or LIGHT. Additionally, a user can press any of the buttons on the back of the clock 1 to stop the alarm sound (the circuitry in FIG. 12 being provided for this effect).

The SELECTOR button shown in FIG. 5 permits selecting temperature reading (C or F), 12 or 24 clock display, and month-day or day-month calendar display when the sensor switch is located on the OFF or LIGHT position. The ALARM button is used to activate and deactivate the daily alarm and hourly chime function in any mode, i.e., when the switch is located on any of its three ON, OFF, and LIGHT positions. The RESET button found on the right side in FIG. 5 is depressed to reset any or all of the functions when the switch is in any of its three ON, OFF and LIGHT positions.

Referring to FIGS. 1 and 8-11, the multifunctional clock can be calibrated or reset to display any or all of the noted functions, in the following manner.

When initializing or calibrating the clock, e.g. upon depressing the RESET button, the CLOCK mode is automatically displayed, with the following default settings: the hour displayed in the 12 hour mode; the date displayed in the month/day format; the time automatically set to 12:00 a.m. on Jan. 1, 2002; the daily alarm and hourly chime function disabled; the daily alarm time set to 12:00 a.m.; and the temperature display set to Celsius. To set the time, the switch is slid to OFF position, the MODE button is depressed to select CLOCK mode and the SET button is pressed and held for two seconds until a beeping sound is emitted. The hour digits will then blink upon the display screen 3. The MODE button is then depressed to set the hour with the SET button then being depressed once to cause the minute digits to blink. The MODE button is then depressed to set the minute.

The SET button is then depressed once to cause the Alarm Hour digits to blink (the alarm AL icon will turn on). The MODE button is then pressed to set the Alarm Hour, with the AL icon ON. The SET button is then pressed once, to cause the alarm minute digits to blink, with the AL icon turning on. The MODE button is then pressed to set the alarm minute (AL icon ON), followed by pressing the SET button once, to return back to the clock display.

To set the date, the switch is slid to the OFF position, with the MODE button depressed to select CALENDAR mode. The SET button is depressed and held for two seconds until a beeping sound is emitted. The year digits will then blink. The MODE button is depressed to set the year, followed by depressing the SET button once to cause the month digits to blink. The MODE button is then pressed to set the month, followed by pressing the SET button once to cause the day digits to blink. The MODE button is then pressed to set the day, followed by pressing the SET button once to return back to the calendar display.

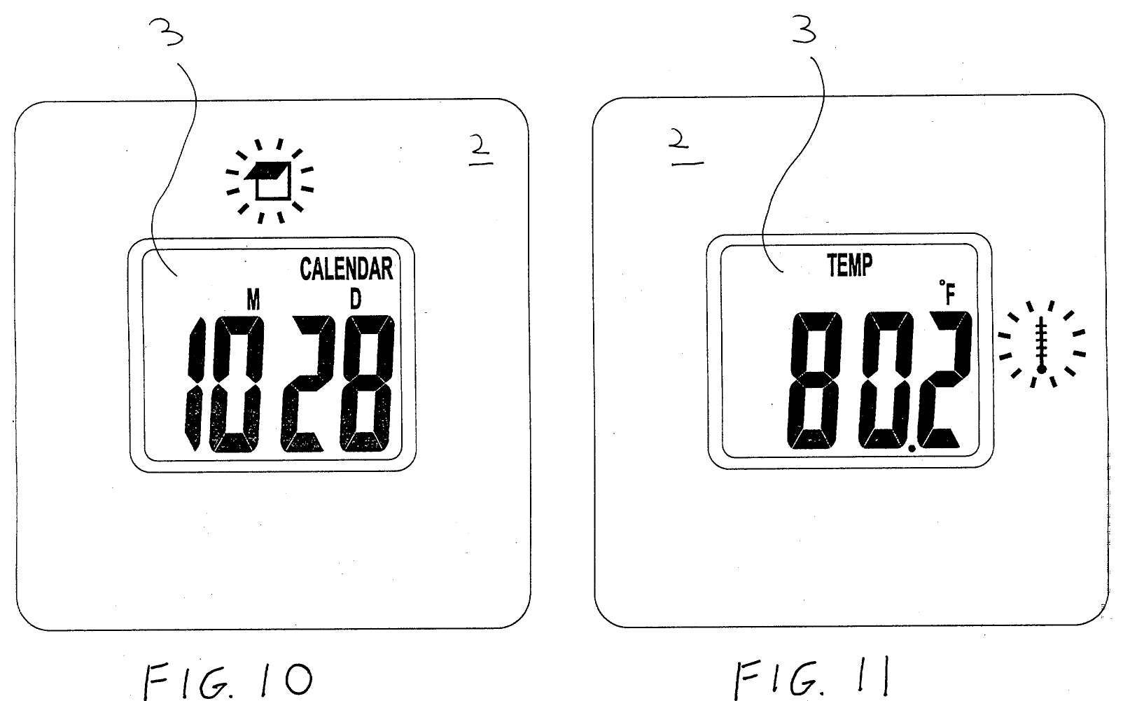

The alarm and hourly chime setting can be set in any of the ON, OFF or LIGHT positions of the switch by pressing the ALARM button once to activate the alarm function (Alarm ON), with the “((.))” icon shown in FIGS. 1 and 8 then being displayed. The ALARM button is then depressed once to activate the hourly chime function, i.e., the BELL icon will turn on. The ALARM button is then depressed once to deactivate the alarm function (Alarm OFF), with the “((.))” icon then turning off. The ALARM button is then depressed once to deactivate the hourly chime function with the BELL icon turning off. When the time for the set alarm is reached, the alarm will sound for thirty seconds with the backlighting turning on, until any button is depressed to silence the alarm.

To turn on the backlighting on the screen 3, the sliding switch is slid to the LIGHT position. Once the sensor is activated, the backlighting and LED indicator of the current mode with turn on and delay (appear) for three seconds (the logo appearing on the LCD screen 3 will also turn on and delay (appear) for three seconds). The sliding switch is then slid to ON position to turn on the backlighting and LED indicator of the current mode with a three second delay when the mode is changing (the current mode logo on the screen will also turn on and delay for three seconds). For LED indication, the backlighting will turn on and delay for three seconds when the mode is changing.

To select particular format, The switch is slid to the OFF position, with the MODE button depressed to select CLOCK mode. The SELECTOR button is then depressed to select the 12 or 24 hour format, followed by depressing the MODE button to select the CALENDAR mode. The SELECTOR button is then depressed to select the month/day or day/month display format, followed by pressing the MODE button to select temperature (TEMP.) mode. The SELECTOR button is the depressed to select the C or F display format for temperature.

Other features provided by the present invention include temperature measurement sensing in the range of −10C to 50C with one decimal place or about 14F to 122F. The time accuracy is +/−sixty seconds per month, with battery life being approximately 12 months for the multifunctional clock. When the mode is changed from CLOCK to CALENDAR or TEMP, the current mode will always be displayed. Thus there is no need to change back to the CLOCK mode automatically. The alarm will activate in every mode selected. For example, if the current mode is the CALENDAR mode, when the alarm time is reached, the display mode will automatically change into the CLOCK mode. After the alarm stops, the mode will switch back to the CALENDAR mode.

Stand-by current is provided when the switch is ON. Thus the power consumption can be cut down when the switch is slid to the OFF position. The sound level of the alarm is not less than 60 decibels. The temperature sensor updates readings every two minutes while the sensing gap for the sensors, other than the temperature sensor, is one second. A beeping sound emits when a mode change is made with the switch in either the OFF or ON positions or in the LIGHT position for sensing the backlighting. The backlighting will also activate and delay for three seconds when a mode is changed with the switch in either the OFF or ON positions or when the hourly chime function is enabled (backlighting immediately turns on). Additionally, the function logos displayed upon the LCD screen will also turn on and delay for three seconds when the mode is changed with the switch is in either the OFF or ON positions, when the switch is in the LIGHT position for activating the backlighting, when alarm time is reached, or when the hourly chime function is enabled.

The preceding description of the present invention is merely exemplary and is not intended to limit the scope thereof in any way.

What is claimed is:

1. A multifunctional clock structured and arranged to display time, calendar and time in alternating fashion on the same screen.

2. The clock of claim 1, wherein the screen is a liquid crystal.

3. The clock of claim 2, wherein an icon denoting the displayed function also illuminates upon the clock face.

4. The clock of claim 3 wherein the icon is separately illuminated apart from the liquid crystal display.

5. The clock of claim 1, wherein an icon denoting the displayed function also illuminates upon the clock face.

6. The clock of claim 1, additionally comprising the function of an activated audio alarm.

7. The clock of claim 2, additionally comprising the function of an activated audio alarm.

8. The clock of claim 3, additionally comprising the function of an activated audio alarm.

9. The clock of claim 4, additionally comprising the function of an activated audio alarm.

10. The clock of claim 5, additionally comprising the function of an activated audio alarm.

11. The clock of claim 1, additionally comprising a backlighting function for the display which is separately activated apart from display of the other functions.

12. The clock of claim 11, wherein at least one of said backlighting function and separately-activated functions are activated by motion.

13. The clock of claim 2, additionally comprising a backlighting function for the display which is separately activated apart from display of the other functions.

14. The clock of claim 13, wherein at least one of said backlighting function and separately-activated functions are activated by motion.

15. The clock of claim 3, additionally comprising a backlighting function for the display which is separately activated apart from display of the other functions.

16. The clock of claim 15, wherein at least one of said backlighting function and separately-activated functions are activated by motion.

17. The clock of claim 4, additionally comprising a backlighting function for the display which is separately activated apart from display of the other functions.

18. The clock of claim 17, wherein at least one of said backlighting function and separately-activated functions are activated by motion.

19. The clock of claim 5, additionally comprising a backlighting function for the display which is separately activated apart from display of the other functions.

20. The clock of claim 19, wherein at least one of said backlighting function and separately-activated functions are activated by motion.
